(19) United States
(12) Patent Application Publication
(10) Pub. No.: US 2005/0071168 A1
(43) Pub. Date: Mar. 31, 2005

(54) Method and apparatus for authenticating a user using verbal information verification

(76) Inventors: Biing-Hwang Juang, Warren Township, NJ (US); Padma Ramesh, New Providence, NJ (US)

Correspondence Address: Ryan, Mason & Lewis, LLP, Suite 205, 1300 Post Road, Fairfield, CT, 06824, US

(21) Appl. No.: 10/674,286

(22) Filed: Sep. 29, 2003

(51) Int. Cl. G10L 11/00

(52) U.S. Cl. 704/273

(57) ABSTRACT

A method and apparatus are provided for authenticating a user using verbal information verification techniques. The user is challenged with one or more questions that the user has previously answered. A user's spoken utterances are first processed using automatic speech recognition techniques, and optionally utterance verification techniques. The recognized text that has been extracted from the user's spoken words is compared with the information recorded in a user profile corresponding to the answers provided by the user during the enrollment phase, using word spotting techniques. If the user's spoken answer is correct, the user may obtain access to a protected resource. If the user's spoken answer provided during verification deviates from the answer that was provided during enrollment, the disclosed verbal input verification server can still correctly recognize the answer.

### FIELD OF THE INVENTION

The present invention relates generally to user authentication techniques and more particularly, to methods and apparatus for authenticating a user using a question-response procedure.

### BACKGROUND OF THE INVENTION

A number of security issues arise when computers or other resources are accessible by humans. Most computers and computer networks incorporate computer security techniques, such as access control mechanisms, to prevent unauthorized users from accessing remote resources. Human authentication is the process of verifying the identity of a user in a computer system, often as a prerequisite to allowing access to resources in the system. A number of authentication protocols have been proposed or suggested to prevent the unauthorized access of remote resources. In one variation, each user has a password that is presumably known only to the authorized user and to the authenticating host. Before accessing the remote resource, the user must provide the appropriate password, to prove his or her authority.

A simple password mechanism, however, often does not provide sufficient security for a given application, since many users select a password that is easy to remember and therefore easy for an attacker to guess. In order to improve the security of passwords, the number of login attempts is often limited (to prevent an attacker from guessing a password) and users are often required to change their password periodically. Some systems use simple methods such as minimum password length and prohibition of dictionary words to evaluate a user selected password at the time the password is selected, to ensure that the password is not particularly susceptible to being guessed. In addition, many systems encrypt a password before it is transmitted from a user's terminal, to ensure that the password cannot be read when it is transmitted.

One-time, challenge-response passwords have been proposed as a mechanism for further increasing security. Generally, users are assigned a secret key, presumably known only to the user and the remote resource. The secret key may be stored, for example, on a pocket token or a computer-readable card. Upon attempting to access a desired remote resource, a random value, known as a “challenge,” is issued to the user. The user then generates an appropriate “response” to the challenge by encrypting the received challenge with the user's secret key (read from the pocket token or computer-readable card), using a known encryption algorithm, such as the data encryption standard (DES). The user transmits the calculated response to the desired remote resource, and obtains access to the requested resource if the response is accurate. In order to ensure that the pocket token or computer-readable card is being utilized by the associated authorized user, the security may be supplemented by requiring the user to enter a memorized PIN (personal identification number) or password.

In a call center environment, Verbal Information Verification (VIV) techniques are often employed to authenticate users by testing their knowledge of personal information, such as their social security number, date of birth or mother's maiden name. Such queries can be employed as a primary access control scheme in lieu of the above described password mechanisms or as a secondary mechanism when the user has forgotten his or her password, or needs to change a password or obtain a new one. In any case, the queries can be thought of as hints to “pull” a fact from a user's long term memory. Verbal Information Verification is based on the spoken content of the utterance, rather than the speaker's voice characteristics.

While such query-based authentication protocols are convenient, they suffer from a number of limitations, which if overcome, could further improve the utility and security of such authentication schemes. For example, most authentication systems employing user queries require a human operator to process the spoken answers of each user. The required human intervention delays the ability of the user to access the desired resource, and increases the costs of processing each access request. A need therefore exists for an authentication technique that provides the convenience and familiarity of traditional query directed authentication without the need for human intervention. A further need exists for a method and apparatus for resetting a password that provides a similar level of security and convenience as the primary password scheme.

### SUMMARY OF THE INVENTION

Generally, a method and apparatus are provided for authenticating a user using verbal information verification techniques. During an enrollment phase, the user answers one or more questions. The question answers are typically stored in a user profile. During a primary or secondary verification phase, the user is challenged with one or more questions that the user has previously answered. The user may answer questions until a level of security for a given application is exceeded, for example, based on a sum of security weights of correctly answered questions.

A user's spoken utterances are first processed using automatic speech recognition techniques, and optionally utterance verification techniques. The recognized text that has been extracted from the user's spoken words is compared with the information recorded in a user profile corresponding to the answers provided by the user during the enrollment phase, using word spotting techniques. If the user's spoken answer is correct, the user may obtain access to a protected resource. If the user's spoken answer provided during verification deviates from the answer that was provided during enrollment, the disclosed verbal input verification server can still correctly recognize the answer. For example, if the challenge question is “Birth Place,” and the precise answer provided by the user during enrollment was “Bronx, N.Y.,” then the verbal input verification server will still recognize the following exemplary variations in the spoken answer during the verification phase: “I was born in the Bronx;” “Bronx, N.Y.” or “The Bronx is where I was born.”

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment in which the present invention can operate;

FIG. 2 is a schematic block diagram illustrating the verbal input verification server of FIG. 1 in further detail;

FIG. 3 is a sample table from an exemplary question database of FIGS. 1 and 2;

FIG. 4 is a sample table from an exemplary user database of FIGS. 1 and 2;

FIG. 5 is a flow chart describing an exemplary implementation of an enrollment process of FIG. 2 incorporating features of the present invention;

FIG. 6 is a flow chart describing an exemplary implementation of a verification process of FIG. 2 incorporating features of the present invention; and

FIG. 7 is a schematic block diagram illustrating the processing of a spoken utterance by the verbal input verification server of FIG. 1.

### DETAILED DESCRIPTION

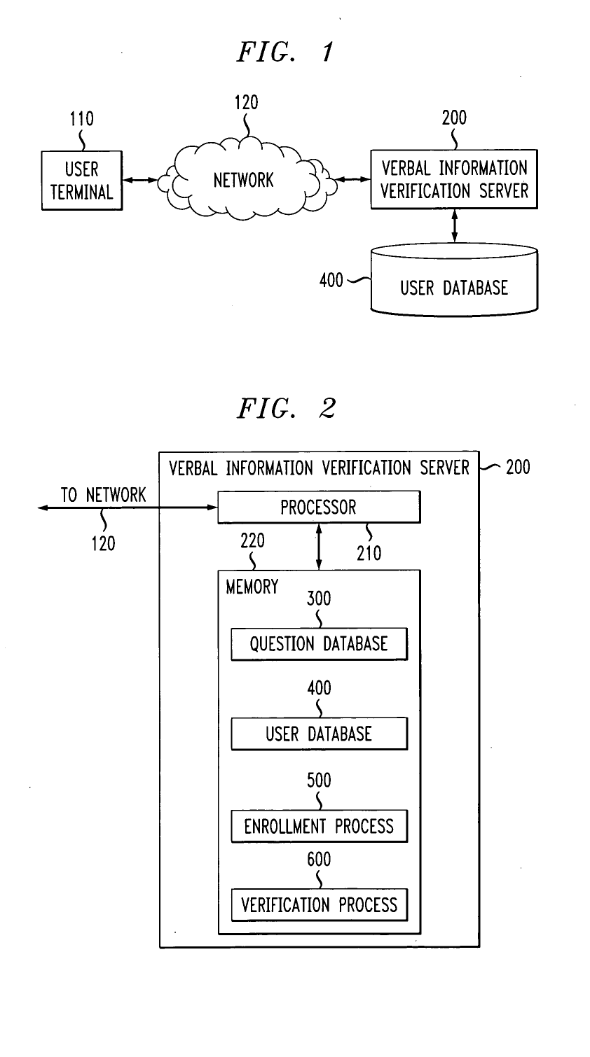

FIG. 1 illustrates an exemplary network environment in which the present invention can operate. As shown in FIG. 1, a user employing a user device 110 attempts to access a remote protected resource over a network 120. In order to access the protected resource, such as a hardware device or bank account, the user must communicate with a verbal input verification server 200, discussed further below in conjunction with FIG. 2, to answer one or more previously answered questions according to a query-directed protocol. The user has previously answered questions during an enrollment phase. The network(s) 120 may be any combination of wired or wireless networks, such as the Internet and the Public Switched Telephone Network (PSTN). The verbal input verification server 200 may be associated, for example, with a call center or web server. It is also noted that the enrollment and authentication functions performed by the verbal input verification server 200 can be performed by two distinct computing systems. The user device 110 may be a telephone, personal computer or another communication that allows the user to speak with the verbal input verification server 200.

The present invention employs a query-based authentication protocol as a primary or secondary access control system. Thus, during an enrollment phase, the user must answer one or more questions. A security weight can optionally be assigned to each of the selected questions to estimate the level of difficulty an attacker would have to answer the question correctly. The answers to the questions are typically stored in a user profile record. During a primary or secondary verification phase, such as when the user attempts to access a resource that is protected using the present invention, the user is challenged with one or more questions that the user has previously answered. The user may answer questions until a level of security for a given application is exceeded, for example, based on a sum of security weights of correctly answered questions. According to one aspect of the invention, the user's answers are processed using automatic speech recognition and utterance verification (ASR/UV) techniques, so that any variations in the user's spoken answer may be correctly recognized by the verbal input verification server 200. For example, if the challenge question is “Birth Place,” and the precise answer provided by the user during enrollment was “Bronx, N.Y.,” then the verbal input verification server 200 will still recognize the following exemplary variations in the spoken answer during the verification phase: “I was born in the Bronx;” “Bronx, N.Y.” or “The Bronx is where I was born.”

FIG. 2 is a schematic block diagram of an exemplary verbal input verification server 200 incorporating features of the present invention. The verbal input verification server 200 may be any computing device, such as a personal computer, work station or server. As shown in FIG. 2, the exemplary verbal input verification server 200 includes a processor 210 and a memory 220, in addition to other conventional elements (not shown). The processor 210 operates in conjunction with the memory 220 to execute one or more software programs. Such programs may be stored in memory 220 or another storage device accessible to the verbal input verification server 200 and executed by the processor 210 in a conventional manner.

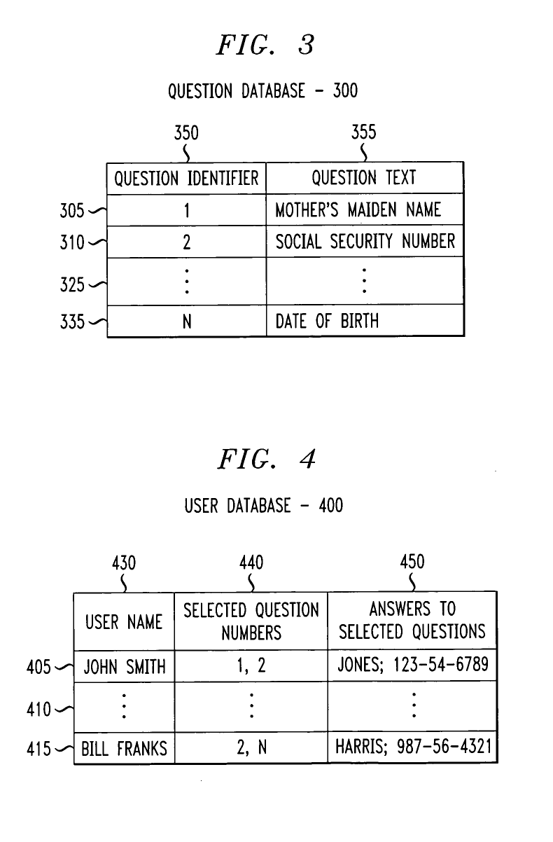

For example, as discussed below in conjunction with FIGS. 3 through 6, the memory 220 may store a question database 300, a user database 400, an enrollment process 500 and a verification process 600. Generally, the question database 300 records questions that the user will answer during an enrollment phase. The enrollment process 500 presents the user with one or more questions that the user will answer. The verification process 600 employs a verbal input verification protocol incorporating features of the present invention for primary or secondary authentication of a user using queries.

FIG. 3 is a sample table from an exemplary question database of FIGS. 1 and 2. As previously indicated, the question database 300 contains one or more questions that the verbal input verification server 200 presents to the user to answer during an enrollment phase. As shown in FIG. 3, the question database 300 consists of a plurality of records, such as records 305-335, each associated with a different question. For each question, the question database 300 records a question identifier and question text in fields 350 and 355, respectively. For example, question number 1, in record 305, queries the user for his or her mother's maiden name. For a detailed discussion of additional suitable questions in a suitable query directed protocol, see U.S. patent application Ser. No. 10/626,483, entitled “Method and Apparatus for Authenticating a User Using Query Directed Passwords,” (Attorney Docket Number 502078) filed Jul. 24, 2003, assigned to the assignee of the present invention and incorporated by reference herein.

FIG. 4 is a sample table from an exemplary user database of FIGS. 1 and 2. The user database 400 records the questions and answers provided by the user during the enrollment phase. As shown in FIG. 4, the user database 400 consists of a plurality of records, such as records 405-415, each associated with a different enrolled user. For each enrolled user, the user database 400 identifies the user in field 430, and the selected question numbers in field 440 (corresponding to the exemplary questions in FIG. 3) with the corresponding answers in field 450. In addition, as previously indicated, a security weight can optionally be assigned to each question to estimate the level of difficulty an attacker would have to answer the question correctly.

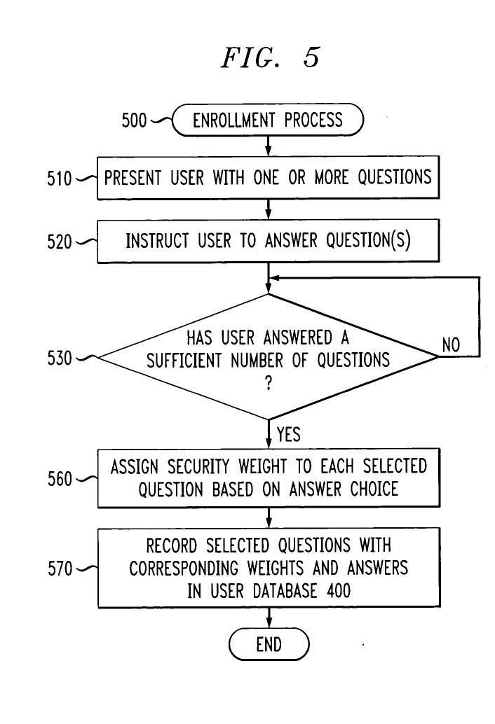

FIG. 5 is a flow chart describing an exemplary implementation of an enrollment process 500 of FIG. 2 incorporating features of the present invention. As previously indicated, the exemplary enrollment process 500 presents the user with one or more questions that the user will answer. As shown in FIG. 5, a user is initially presented with one or more questions during step 510. The user is instructed during step 520 to answer the questions. It is noted that the answers during enrollment can be provided in spoken or textual form. The answers are typically stored in the user profile 400 as text.

A test is performed during step 530 to determine if the user has answered a sufficient number of questions. If it is determined during step 530 that the user has not answered enough questions, then program control returns to step 530. If, however, it is determined during step 530 that the user has answered enough questions, then a weight is assigned to each answered question during step 560 to estimate the level of difficulty an attacker would have to answer the question correctly. Generally, the weights are inversely related to the probability of an answer being chosen by a wide population of users. The selected questions, and corresponding weights and answers are recorded in the user database 400 during step 570 before program control terminates.

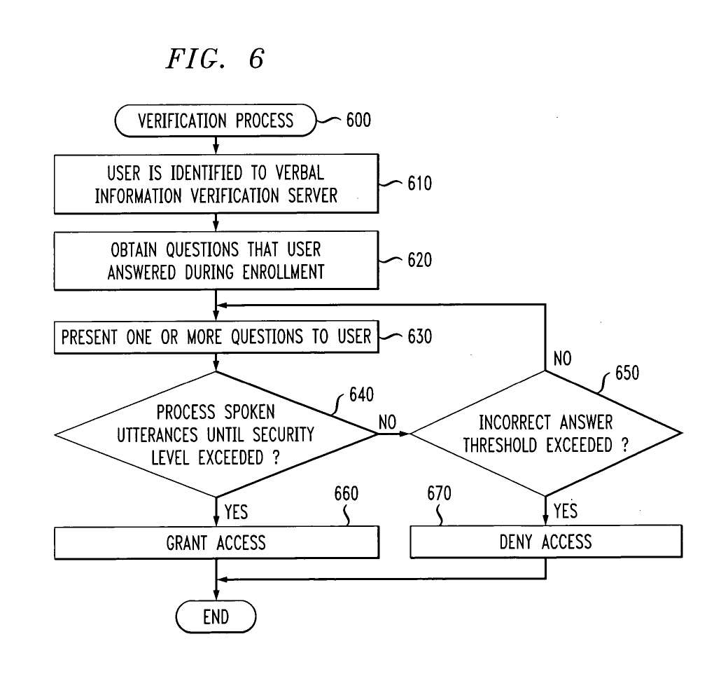

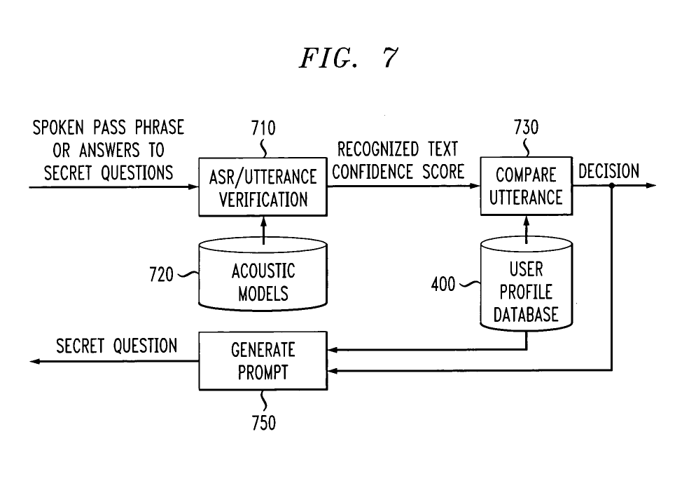

FIG. 6 is a flow chart describing an exemplary implementation of the verification process 600 of FIG. 2 incorporating features of the present invention. As previously indicated, the verification process 600 employs a verbal input verification protocol incorporating features of the present invention for primary or secondary authentication of a user using queries. As shown in FIG. 6, the user initially identifies himself (or herself) to the verbal input verification server 200 during step 610. During step 620, the verification process 600 obtains one or more questions from the user database 400 that the user answered during the enrollment phase. The questions are presented to the user during step 630 and the spoken utterances are processed in accordance with the present invention (as discussed below in conjunction with FIG. 7) until a level of security for the application is exceeded during step 640 (to grant access during step 660) based on the sum of security weights of correctly answered questions, or until a predefined threshold is exceeded during step 650 for incorrect answers (to deny access during step 670).

FIG. 7 is a schematic block diagram illustrating the processing of the spoken utterances during step 640 by the verbal input verification server 200 of FIG. 1. As shown in FIG. 7, the user's spoken utterances are first processed through an automatic speech recognizer (ASR) 710. The automatic speech recognizer 710 may optionally include an utterance verification (UV) stage that provides a confidence score for the recognized utterance. Both the ASR and UV stages use the acoustic models 720 of the speech units for comparison. For a detailed discussion of suitable automatic speech recognition and utterance verification techniques, see, for example, “Automatic Verbal Information Verification for User Authentication,” IEEE Trans. Speech and Audio Processing, vol. 8, no.5, 585-596, (September 2000); Rabiner and Juang, Fundamentals of Speech Recognition, Prentice-Hall (1993); or “General Phrase Speaker Verification Using Subword Background Models and Likelihood Ration Scoring,” Proc. Int'l Conf. on Spoken Language Processing (ICSLP), Philadelphia, Pa. (1996), each incorporated by reference herein.

The recognized text generated by the automatic speech recognizer 710, optionally with the confidence score, are provided to a comparator 730. The automatic speech recognizer 710 may optionally only provide a top-N list. The recognized text that has been extracted from the user's spoken words is then compared at stage 730 with the textual data from the user profile 400 corresponding to the answers provided by the user during the enrollment phase. A decision is then obtained at stage 750 to determine if the user's spoken answer is correct. Based on this decision, the user may obtain access, may be rejected or a further question may be asked by the verification process 600. Generally, when the user incorrectly answers a question, or if the confidence score is between the acceptance and rejection thresholds, additional questions can be asked, and a cumulative confidence score computed. If the cumulative confidence score exceeds a threshold, the user can be accepted.

Generally, the verbal information verification server 200 compares the spoken answers provided during a verification phase to the textual form that was obtained during the enrollment phase, using known word spotting techniques. In this manner, if the user's spoken answer provided during verification deviates from the answer that was provided during enrollment, the verbal input verification server 200 can still correctly recognize the answer. For example, if the challenge question is “Birth Place,” and the precise answer provided by the user during enrollment was “Bronx, N.Y.,” then the verbal input verification server 200 will still recognize the following exemplary variations in the spoken answer during the verification phase: “I was born in the Bronx;” “Bronx, N.Y.” or “The Bronx is where I was born.”

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

1. A method for authenticating a user, comprising:
obtaining an asserted identity of said user;
presenting one or more questions to said user that said user has previously answered; and
processing spoken answers to said one or more questions using an automatic speech recognition technique.

2. The method of claim 1, wherein said processing step is performed until a predefined security threshold is satisfied.

3. The method of claim 2, wherein said predefined security threshold is based on a sum of security weights of correctly answered questions.

4. The method of claim 1, further comprising the step of processing said answer using an utterance verification technique.

5. The method of claim 1, wherein said processing step further comprises the step of converting said spoken answers to a textual form and comparing said textual form to answers obtained during an enrollment phase.

6. The method of claim 1, wherein said processing step further comprises the step of obtaining a confidence score for a recognized version of said spoken answer.

7. The method of claim 1, wherein said processing step further comprises the step of employing word spotting techniques to determine if said spoken answer matches an answer obtained during an enrollment phase.

8. The method of claim 1, wherein said authentication is performed in connection with the resetting of a password of said user.

9. An apparatus for authenticating a user, comprising:
a memory; and
at least one processor, coupled to the memory, operative to:
obtain an asserted identity of said user;
present one or more questions to said user that said user has previously answered; and
process spoken answers to said one or more questions using an automatic speech recognition technique.

10. The apparatus of claim 9, wherein said processor is further configured to process said spoken answers until a predefined security threshold is satisfied.

11. The method of claim 10, wherein said predefined security threshold is based on a sum of security weights of correctly answered questions.

12. The apparatus of claim 9, wherein said processor is further configured to process said answer using an utterance verification technique.

13. The apparatus of claim 9, wherein said processor is further configured to convert said spoken answers to a textual form and comparing said textual form to answers obtained during an enrollment phase.

14. The apparatus of claim 9, wherein said processor is further configured to obtain a confidence score for a recognized version of said spoken answer.

15. The apparatus of claim 9, wherein said processor is further configured to employ word spotting techniques to determine if said spoken answer matches an answer obtained during an enrollment phase.

16. An article of manufacture for authenticating a user, comprising a machine readable medium containing one or more programs which when executed implement the steps of:
obtaining an asserted identity of said user;
presenting one or more questions to said user that said user has previously answered; and
processing spoken answers to said one or more questions using an automatic speech recognition technique.

17. The article of manufacture of claim 16, further comprising the step of processing said answer using an utterance verification technique.

18. The article of manufacture of claim 16, wherein said processing step further comprises the step of converting said spoken answers to a textual form and comparing said textual form to answers obtained during an enrollment phase.

19. The article of manufacture of claim 16, wherein said processing step further comprises the step of obtaining a confidence score for a recognized version of said spoken answer.

20. The article of manufacture of claim 16, wherein said processing step further comprises the step of employing word spotting techniques to determine if said spoken answer matches an answer obtained during an enrollment phase.
